(19) United States
(12) Patent Application Publication
(10) Pub. No.: US 2015/0281091 A1
(43) Pub. Date: Oct. 1, 2015

(54) CONTROL APPARATUS, NODE, COMMUNICATION SYSTEM, COMMUNICATION METHOD, AND PROGRAM

(71) Applicant: NEC CORPORATION, Tokyo (JP)

(72) Inventors: Takayuki Sasaki, Tokyo (JP); Yoichiro Morita, Tokyo (JP); Remi Ando, Tokyo (JP); Hideyuki Shimonishi, Tokyo (JP); Kentaro Sonoda, Tokyo (JP); Yoichi Hatano, Tokyo (JP)

(73) Assignee: NEC Corporation, Tokyo (JP)

(21) Appl. No.: 14/435,601

(22) PCT Filed: Oct. 11, 2013
(86) PCT No.: PCT/JP2013/077763

§ 371 Date: Apr. 14, 2015

(30) Foreign Application Priority Data
Oct. 15, 2012 (JP) 2012-227921

(51) Int. Cl. H04L 12/803; H04L 12/801

(52) U.S. Cl. CPC H04L 47/125; H04L 47/11

(57) ABSTRACT

A control apparatus, comprises: a traffic information collection unit that collects per-flow traffic information from a control target node for performing packet processing per flow; a traffic analysis unit that performs totalization per flow based the traffic information to determine a flow whose traffic is expected to increase and a corresponding time period; and a presetting unit that presets control information for processing the determined flow in a node on a path that corresponds to the flow whose traffic is expected to increase during the determined time period.

### TECHNICAL FIELD

### Reference to Related Application

The present invention is based upon and claims the benefit of the priority of Japanese patent application No. 2012-227921, filed on Oct. 15, 2012, the disclosure of which is incorporated herein in its entirety by reference thereto.

The present invention relates to a control apparatus, a node, a communication system, a communication method, and a program. In particular, it relates to: a control apparatus that controls target nodes in a centralized manner; a node; a communication system; a communication method; and a program.

### BACKGROUND

In recent years, a technique referred to as OpenFlow has been proposed (see Non-Patent Literatures 1 and 2). OpenFlow recognizes communications as end-to-end flows and performs path control, failure recovery, load balancing, and optimization on a per-flow basis. Each OpenFlow switch according to Non-Patent Literature 2 has a secure channel for communication with an OpenFlow controller and operates according to a flow table suitably added or rewritten by the OpenFlow controller. In the flow table, a set of the following three is defined for each flow: match conditions (Match Fields) against which a packet header is matched; flow statistical information (Counters); and instructions that define at least one processing content (see 4.1 “Flow Table” in Non-Patent Literature 2).

For example, when an OpenFlow switch receives a packet, the OpenFlow switch searches the flow table for an entry having a match condition that matches header information of the received packet (see 4.3 “Match Fields” in Non-Patent Literature 2). If, as a result of the search, the OpenFlow switch finds an entry that matches the received packet, the OpenFlow switch updates the flow statistical information (Counters) and processes the received packet on the basis of a processing content(s) (packet transmission from a specified port, flooding, dropping, etc.) written in the Instructions field of the entry. If, as a result of the search, the OpenFlow switch does not find an entry that matches the received packet, the OpenFlow switch transmits an entry setting request to the OpenFlow controller via the secure channel. Namely, the OpenFlow switch requests the OpenFlow controller to transmit control information for processing the received packet (Packet-In message). The OpenFlow switch receives a flow entry that defines a processing content(s) and updates the flow table. In this way, by using an entry stored in the flow table as control information, the OpenFlow switch performs packet forwarding.

Patent Literature 1 discloses an invention for preventing load increase. According to this invention, a different timer value (an effective period) is set in each of the packet forwarding rules (corresponding to the above flow entries) that are set in relevant packet forwarding apparatuses (corresponding to the above OpenFlow switches). In this way, a path control apparatus (corresponding to the above OpenFlow controller) receives less requests for packet forwarding rules.

### CITATION LIST

### Patent Literature

Patent Literature 1:
Japanese Patent Kokai Publication No. 2011-101245A

### Non-Patent Literature

Non-Patent Literature 1:
Nick McKeown, and seven others, “OpenFlow: Enabling Innovation in Campus Networks,” [online], [searched on Sep. 25, 2012], Internet <URL:http://www.openflow.org/documents/openflow-wp-latest.pdf>NON-PATENT LITERATURE 2:
“OpenFlow Switch Specification” Version 1.1.0 Implemented (Wire Protocol 0x02), [online], [searched on Sep. 25, 2012], Internet <URL:http://www.openflow.org/documents/openflow-spec-v1.1.0.pdf>

### SUMMARY

### Technical Problem

The disclosure of each of the above Patent Literature and Non-Patent Literatures is incorporated herein by reference thereto. The following analysis has been given by the present inventors. As described above, while the configuration of each forwarding node in a centralized-control-type network can be simplified, the load on a control apparatus is increased.

FIG. 12 is a graph illustrating the amount of traffic in a network and change of the load on an OpenFlow controller (OFC). In FIG. 12, the traffic amount rapidly increases a certain time period after the start of a business day. Thereafter, the traffic amount is maintained within a certain range until the end of the business day. A conceivable reason why the traffic amount reaches its peak a certain time period after the start of a business day is that employees start and connect their own terminals to certain servers or data centers at the same time, for example. More specifically, when receiving newly generated packets, OpenFlow switches on communication paths transmit flow entry setting requests to the OFC. Thus, as illustrated in FIG. 12, the load on the OFC changes in a way similar to the traffic amount.

The peak of the load on the OFC illustrated in FIG. 12 is only an example. The load could be significantly increased a plurality of times in a day. In another case, the load could be significantly increased periodically because of operations of a certain application. In either case, if the number of terminals connected or applications used is increased, the load on the OFC is increased. Therefore, necessary countermeasures are demanded.

In this respect, while Patent Literature 1 is effective regarding deletion of a flow entry as the flow entry times out, the load on the control apparatus when initial communications occur cannot be reduced.

An object of the present invention is to provide a control apparatus, a node, a communication system, a communication method, and a program that reduce the peak of the load on the control apparatus in a centralized-control-type network such as the above OpenFlow controller.

### Solution to Problem

According to a first aspect of the present invention, there is provided a control apparatus. The control apparatus comprises a traffic information collection unit that collects per-flow traffic information from a control target node for performing packet processing per flow. Further, the control apparatus comprises a traffic analysis unit that performs totalization per flow based the traffic information to determine a flow whose traffic is expected to increase and a corresponding time period. Moreover, the control apparatus comprises a presetting unit that presets control information for processing the determined flow in a node on a path that corresponds to the flow whose traffic is expected to increase during the determined time period.

According to a second aspect of the present invention, there is provided a node. The node comprises a traffic information provision unit that transmits per-flow traffic information in response to a request from a control apparatus. Further, the node comprises a control information storage unit that stores control information received from the control apparatus. Moreover, the node comprise an entry selection and deletion unit that selects, when a count of preset control information items generated based on the traffic information transmitted to the control apparatus reaches a predetermined count, control information using a predetermined rule from the preset control information items and deletes the selected control information.

According to a third aspect of the present invention, there is provided a communication system. The communication system comprises the control apparatus. Further, the communication system comprises a node configured to transmit the traffic information to the control apparatus and operate in accordance with control information received from the control apparatus.

According to a fourth aspect of the present invention, there is provided a communication method. The communication method comprises, by a control apparatus that controls a node for performing packet processing per flow, collecting per-flow traffic information from the node. Further, the communication method comprises performing totalization per flow based on the traffic information to determine a flow whose traffic is expected to increase and a corresponding time period. Moreover, the communication method comprises presetting control information for processing the determined flow in a node on a path that corresponds to the flow whose traffic is expected to increase during the determined time period. This method is associated with a certain machine, namely, with a control apparatus controlling nodes on a network.

According to a fifth aspect of the present invention, there is provided a program for a computer arranged in a control apparatus that controls nodes that perform packet processing per flow. The program causes the computer to execute collecting per-flow traffic information from the node. Further, the program causes the computer to execute performing totalization per flow based on the traffic information to determine a flow whose traffic is expected to increase and a corresponding time period. Moreover, the program causes the computer to execute presetting control information for processing the determined flow in a node on a path that corresponds to the flow whose traffic is expected to increase during the determined time period. This program can be recorded in a computer-readable (non-transient) storage medium. Namely, the present invention can be embodied as a computer program product.

### Advantageous Effects of Invention

According to the present invention, it is possible to reduce the peak of the load on the control apparatus in a centralized-control-type network.

### BRIEF DESCRIPTION OF THE DRAWINGS

FIG. 1 is a block diagram illustrating a configuration according to an exemplary embodiment of the present invention.

FIG. 2 is a graph illustrating an operation according to the exemplary embodiment of the present invention.

FIG. 3 is a block diagram illustrating a configuration of a communication system according to a first exemplary embodiment of the present invention.

FIG. 4 is a flowchart illustrating an operation of the communication system according to the first exemplary embodiment of the present invention.

FIG. 5 is a block diagram illustrating the operation of the communication system according to the first exemplary embodiment of the present invention.

FIG. 6 is another block diagram illustrating the operation of the communication system according to the first exemplary embodiment of the present invention.

FIG. 7 is another block diagram illustrating the operation of the communication system according to the first exemplary embodiment of the present invention.

FIG. 8 is a graph illustrating the operation of the communication system according to the first exemplary embodiment of the present invention.

FIG. 9 is a table illustrating an operation of selecting an entry to be replaced in a node according to the first exemplary embodiment of the present invention.

FIG. 10 is another table illustrating the operation of selecting an entry to be replaced in a node according to the first exemplary embodiment of the present invention.

FIG. 11 is a graph illustrating another operation of the communication system according to the first exemplary embodiment of the present invention.

FIG. 12 is a graph illustrating the amount of traffic in a network and change of the load on an OpenFlow controller (OFC).

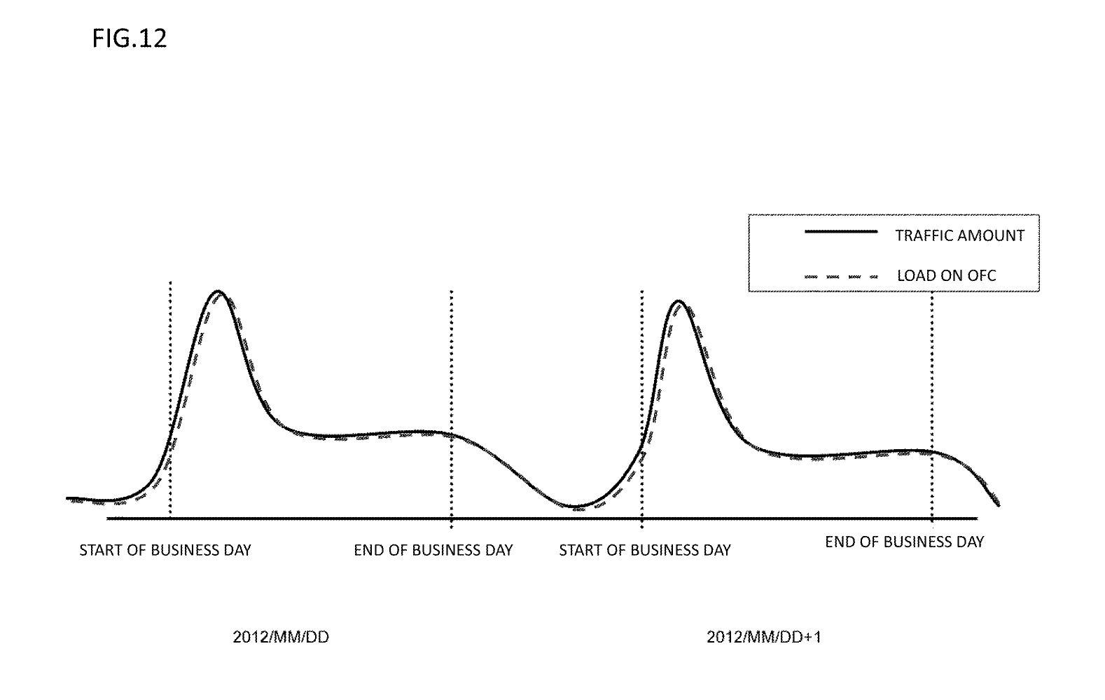

### DESCRIPTION OF EMBODIMENTS

First, an outline of an exemplary embodiment of the present invention will be described with reference to the drawings. In the following outline, various components are denoted by reference characters for the sake of convenience. Namely, the following reference characters are merely used as examples to facilitate understanding of the present invention, not to limit the present invention to the illustrated modes.

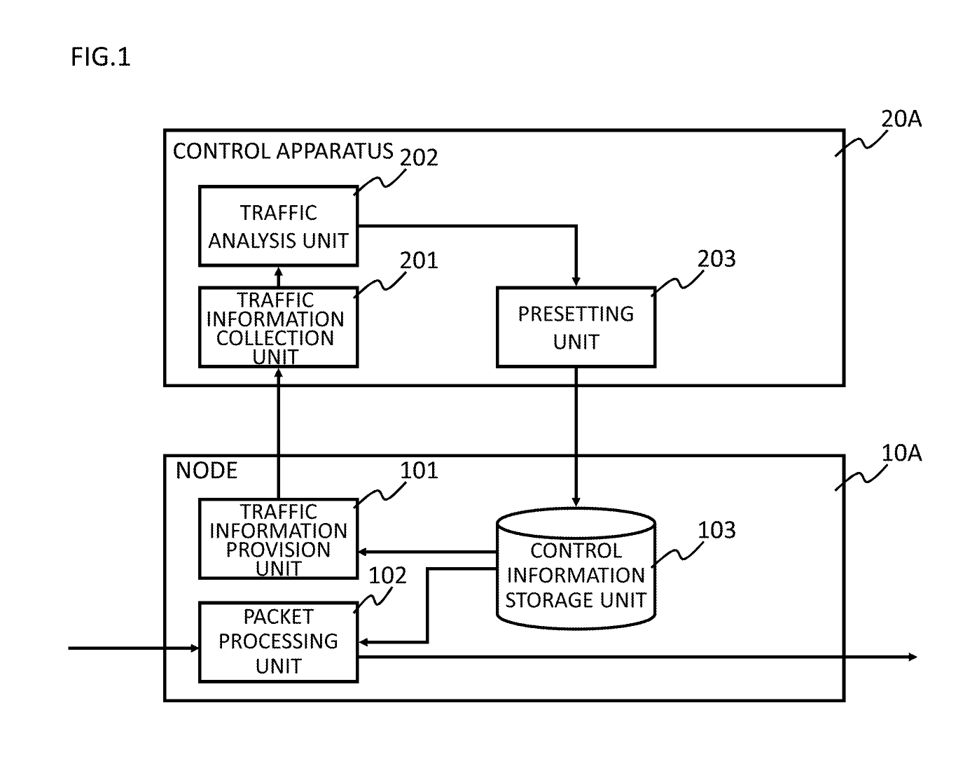

As illustrated in FIG. 1, an exemplary embodiment of the present invention can be realized by a configuration including nodes 10A arranged on a network and a control apparatus 20A that controls the nodes 10A. Each of the nodes 10A includes a traffic information provision unit 101 that transmits per-flow traffic information in response to a request from the control apparatus 20A, a control information storage unit 103 that stores control information received from the control apparatus 20A, and a packet processing unit 102 that processes a received packet by referring to the control information stored in the control information storage unit 103. An OpenFlow switch in Non-Patent Literatures 1 and 2, namely, a communication apparatus having a function of storing a per-flow traffic amount and transmitting the traffic amount to an OpenFlow controller, can be used as each of the node 10A. Of course, other apparatuses having the equivalent functions may be used.

The control apparatus 20A comprises a traffic information collection unit 201 that collects per-flow traffic information from a node 10A controlled by the control apparatus 20A, a traffic analysis unit 202 that performs totalization per flow based on the traffic information to determine flows whose traffic is expected to increase and a corresponding time period, and a presetting unit 203 that presets control information for processing the determined flows in a node on a path that corresponds to the flows whose traffic is expected to increase during the determined time period. The control apparatus 20A can be realized by adding the traffic analysis unit 202 and the presetting unit 203 to an OpenFlow controller in Non-Patent Literatures 1 and 2.

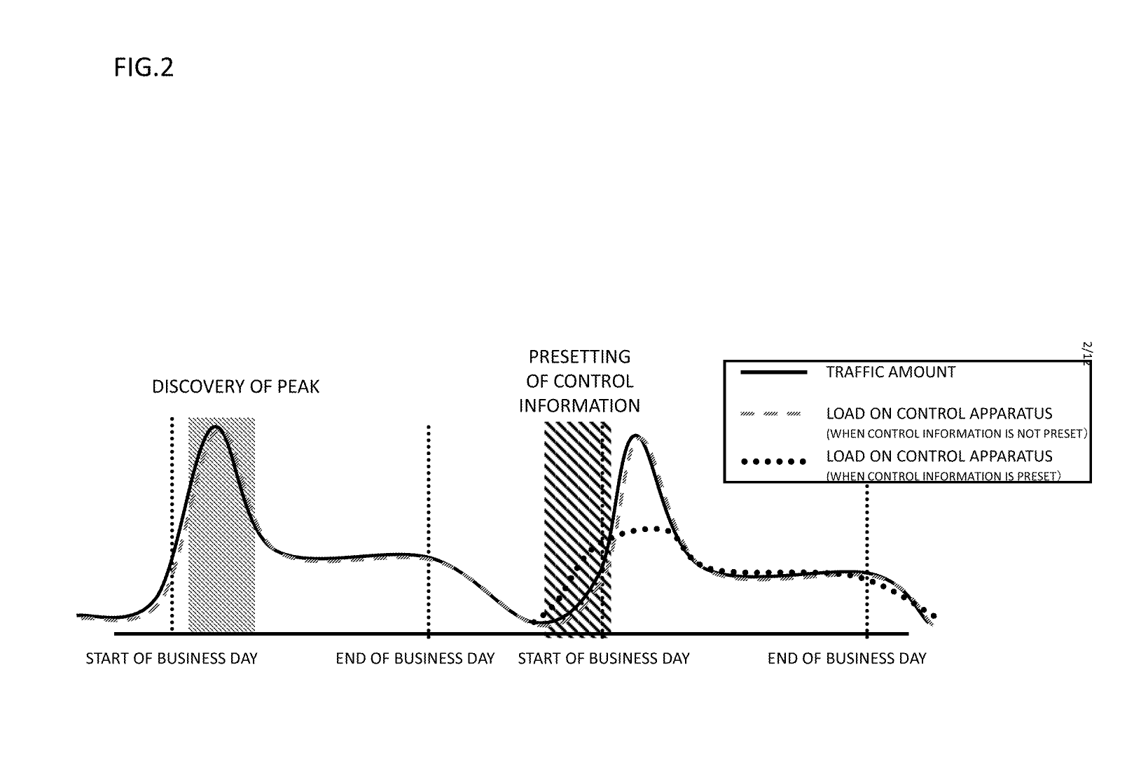

FIG. 2 is a graph illustrating an operation of the control apparatus 20A. The control apparatus 20A according to the present exemplary embodiment determines flows whose traffic is expected to increase and a corresponding time period on the basis of the traffic information collected by the traffic information collection unit 201 (DISCOVERY OF PEAK). Next, the presetting unit 203 presets control information for processing the determined traffic in nodes 10A on the path that corresponds to the flows (PRESETTING OF CONTROL INFORMATION). In this way, when users actually start communications and the traffic amount reaches its peak, the number of requests for generating control information for processing received packets from nodes 10A to the control apparatus 20A is reduced. This is because, since the nodes in which the control information is preset can process received packets by using the preset control information, these nodes do not transmit control information generation requests.

As a result, as illustrated by a dashed line (when control information is not preset) and a dotted line (when control information is preset) in FIG. 2, it is possible to lower the peak of the load on the control apparatus 20A during a certain time period.

### First Exemplary Embodiment

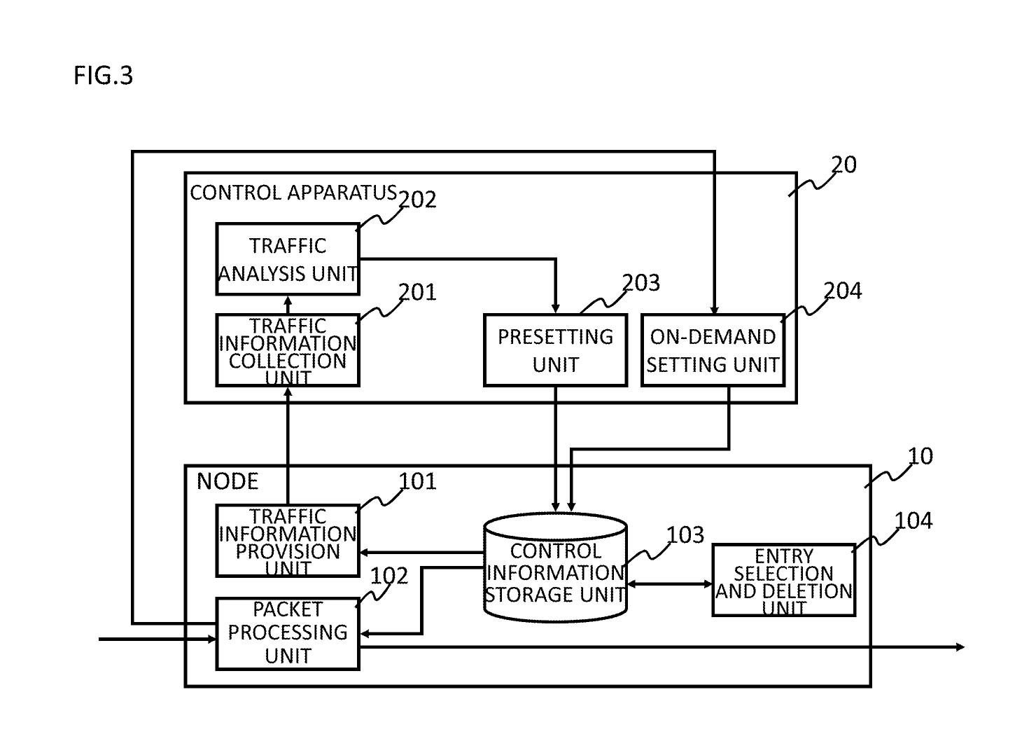

Next, a first exemplary embodiment of the present invention will be described in detail with reference to the drawings. FIG. 3 is a block diagram illustrating a configuration of a communication system according to the first exemplary embodiment of the present invention. As illustrated in FIG. 3, as in FIG. 1, the communication system includes nodes 10 (only one node 10A is illustrated in FIG. 1 for convenience) arranged on a network and a control apparatus 20 that controls the nodes 10.

The control apparatus 20 includes a traffic information collection unit 201, a traffic analysis unit 202, a presetting unit 203, and an on-demand setting unit 204. Hereinafter, the present exemplary embodiment will be described assuming that the control apparatus 20 has functions equivalent to those of an OpenFlow controller in Non-Patent Literatures 1 and 2.

At predetermined time intervals, the traffic information collection unit 201 queries a traffic information provision unit 101 in each node 10 about a value in the field of flow statistical information (Counters) in each entry stored in a control information storage unit 103, so as to collect traffic information. To collect the traffic information, a Read State message in Non-Patent Literature 2 used for querying a switch about a content in a flow table can be used (see A.3.6 “Read State Messages” in Non-Patent Literature 2).

The traffic analysis unit 202 analyzes per-flow traffic amounts per certain time period on the basis of the traffic information collected from each node and selects a plurality of flows whose traffic amount is increased during a peak time period to be flows for which control information is preset. When selecting such preset target flows on the basis of the traffic information, the traffic analysis unit 202 may list flows in descending order of the traffic peak value during a peak time period in a certain node and simply select flows sequentially from the top in the list. Alternatively, the traffic analysis unit 202 may list flows in descending order of the total traffic amount during a peak time period and select flows sequentially from the top in the list. Of course, alternatively, flows that can achieve a better load reduction effect on the control apparatus may be selected by using a statistical method, for example, by obtaining the total traffic amount on each path corresponding to a flow, listing flows in descending order of the total traffic amount, and selecting flows sequentially from the top in the list (flows with more hops are more likely to be selected).

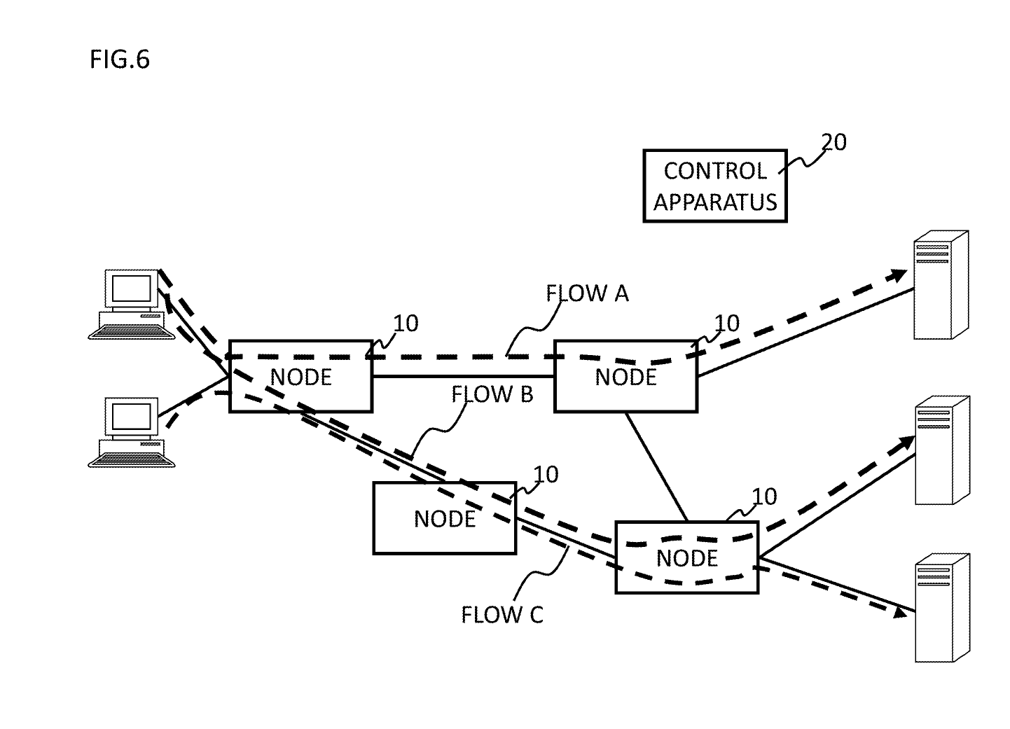

The presetting unit 203 presets control information (flow entries) for processing the determined traffic in the nodes on the paths corresponding to the flows whose traffic amount is increased during the certain time period. As the contents of the control information (flow entries), the matching conditions and actions corresponding to the flows analyzed according to flow per certain time period can be used without modification. The nodes in which the control information (flow entries) are set may be determined by using node information obtained when the traffic information is collected or may be determined on the basis of a network topology as illustrated in FIG. 6. In this operation, some flows having the same destination or the like may be aggregated. The present exemplary embodiment will be described assuming that the presetting unit 203 sets preset control information (flow entries) until the control information storage unit 103 in each node 10 runs out of storage space for the control information. In this way, the possibility that preset control information (a flow entry) is matched when the traffic reaches its peak is increased. Thus, the load reduction effect is increased.

In addition, the presetting unit 203 performs setting so that each node 10 does not delete the preset control information (a flow entry) by time-out. In this way, when a traffic reaches its peak, no preset control information (flow entry) is deleted by time out unintentionally. Thus, the load reduction effect is increased.

In response to a control information (flow entry) transmission request from a node, the on-demand setting unit 204 creates and transmits control information (a flow entry) to the node 10.

Each node 10 includes the traffic information provision unit 101, the control information storage unit 103, a packet processing unit 102, and an entry selection and deletion unit 104. Hereinafter, the present exemplary embodiment will be described assuming that each node 10 includes the functions equivalent to those of an OpenFlow switch in Non-Patent Literatures 1 and 2.

The control information storage unit 103 includes a table or the like that stores control information (flow entries) transmitted from the control apparatus 20.

In the present exemplary embodiment, control information (flow entries) preset by the presetting unit 203 and on-demand control information (flow entries) set in response to control information (flow entry) transmission requests transmitted from the nodes 10 to the control apparatus 20 are not particularly distinguished. However, the types of control information may separately be managed by adding flags or the like to the control information. In this way, for example, aging processing can be performed on the on-demand control information (flow entries) after a certain time period elapses (deletion by time out), not on the preset control information (flow entries).

When receiving a packet from another node or terminal, the packet processing unit 102 searches the control information storage unit 103 for an entry having a matching condition(s) that matches the received packet. As a result of the search, if the packet processing unit 102 finds a matching condition(s) that matches the received packet, the packet processing unit 102 performs the processing content(s) stored in the instruction field of the entry. In this operation, the packet processing unit 102 also updates the value in the field of flow statistical information (Counters) of the entry.

However, if, as a result of the search, the packet processing unit 102 does not find an entry having a matching condition(s) that matches the received packet, the packet processing unit 102 transmits the received packet or information extracted from the received packet to the on-demand setting unit 204 in the control apparatus 20 and requests the control apparatus 20 to transmit a flow entry for processing the received packet.

In response to the request from the control apparatus 20, the traffic information provision unit 101 reads the value in the field of flow statistical information (Counters) from the entry in the control information storage unit 103 and transmits the value to the control apparatus 20.

When the control information storage unit 103 runs out of storage space for control information, the entry selection and deletion unit 104 selects deletion-target control information (a flow entry) from the preset control information (flow entries) stored in the control information storage unit 103 and deletes the selected control information (flow entry). In the present exemplary embodiment, the presetting unit 203 in the control apparatus 20 sets preset control information (flow entries) until the control information storage unit 103 in each node 10 runs out of storage space for control information. Thus, the entry selection and deletion unit 104 performs an operation of switching control information (flow entries).

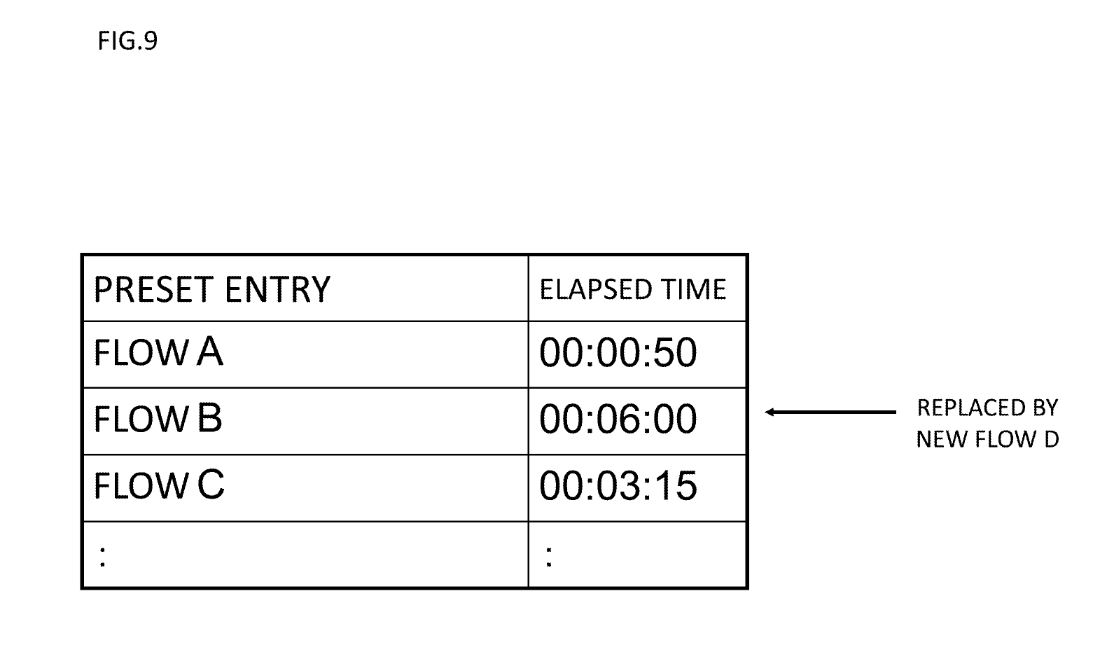

To select control information (a flow entry) to be replaced, the entry selection and deletion unit 104 can use an LRU (Least Recently Used) algorithm or an LFU (Least Frequently Used) algorithm. For example, if the LRU algorithm is used, each entry in the control information storage unit 103 is provided with a field in which elapsed time since the last use (hit) of the corresponding entry is stored. An idle timeout value stored in a flow entry in Non-Patent Literature 2 can be used for the elapsed time since the last use of the entry. In such case, as illustrated in FIG. 9, the entry selection and deletion unit 104 selects an entry having the longest elapsed time since the last use (hit).

If the LRU algorithm is used, an initial value of the elapsed time since the last use may be changed on the basis of flow statistical information. For example, if there is control information (flow entries) A and B used 10 and 100 times the previous day, respectively, different values, for example, 100 and 10 seconds, can be set as the respective initial values of the control information (flow entries) A and B. In this way, by setting a shorter initial value for an entry used more frequently, the entry used more frequently is deleted less frequently in an initial state.

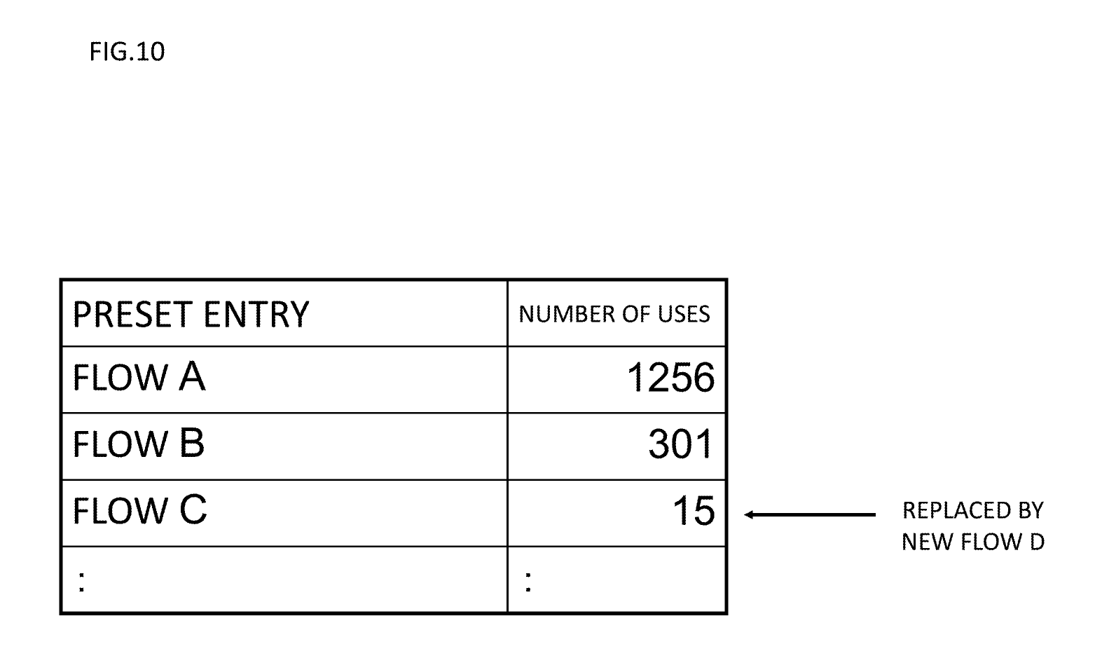

Likewise, if the LFU algorithm is used, each entry in the control information storage unit 103 is provided with a field in which the number of uses (hits) of the entry is stored. The value of “Received Packets” stored as flow statistical information in a flow entry in Non-Patent Literature 2 can be used for the number of uses (hits) of the entry. In such case, as illustrated in FIG. 10, the entry selection and deletion unit 104 selects an entry that has been used (hit) the least since this entry is set. When the LFU algorithm is used, the initial value of the number of uses can also be set on the basis of flow statistical information. For example, if there is control information (flow entries) A and B used 10 and 100 times the previous day, respectively, 10 and 100 may be set as the respective initial values of the number of uses. In this way, an entry used more frequently is deleted less frequently in an initial state.

Of course, other algorithms can be used. For example, instead of the LRU or LFU algorithm, a time-out value, which is longer than that set in on-demand control information (a flow entry) may be set, and entries may be switched by aging processing. In such case, entries may be switched simply by FIFO (First In First Out).

Each unit (processing means) of the control apparatus and the node illustrated in FIG. 3 can be realized by a computer program which causes a computer that constitutes a corresponding one of the control apparatus and the node to use its hardware and execute the above processing.

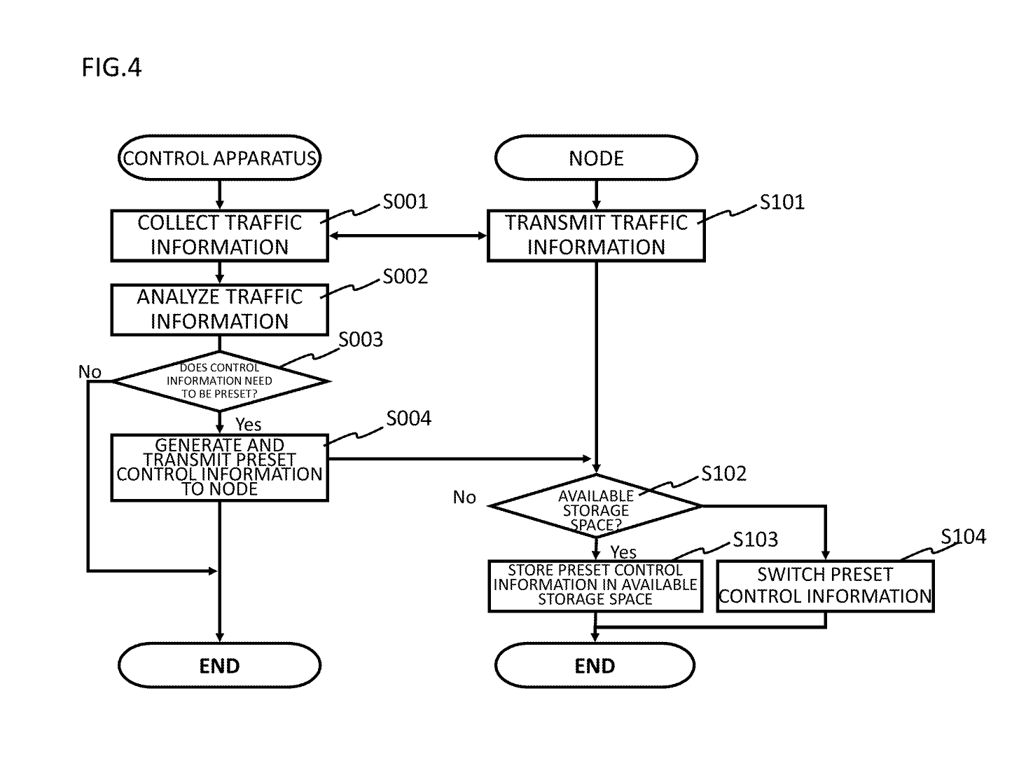

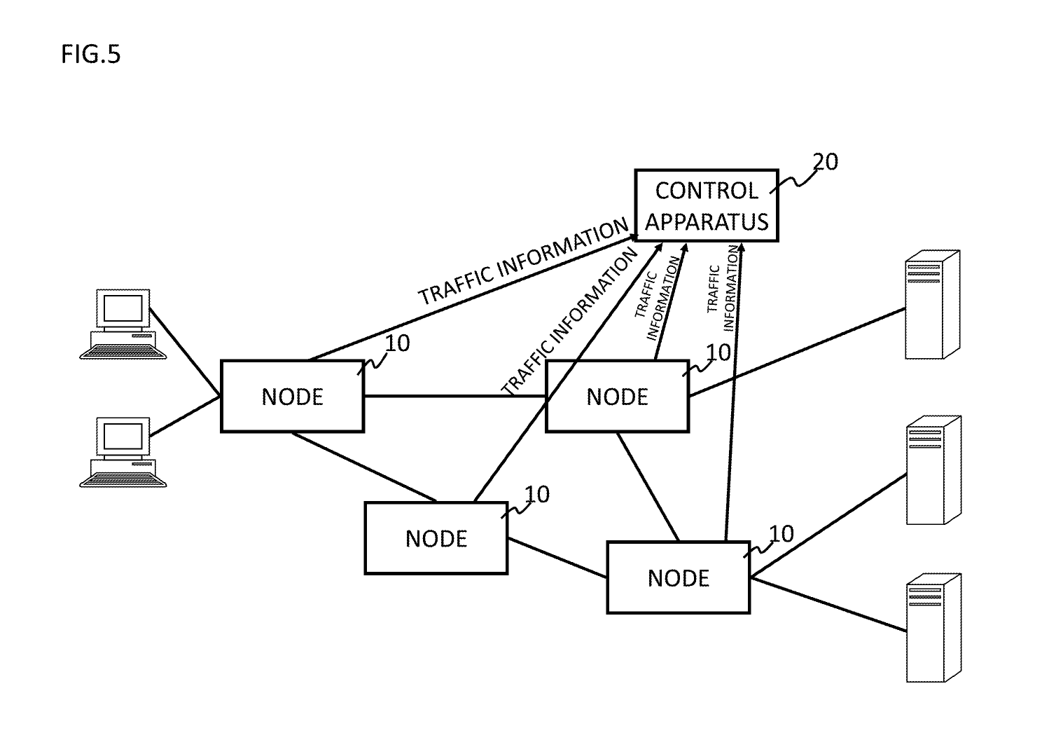

Next, an operation according to the present exemplary embodiment will be described in detail with reference to the drawings. FIG. 4 is a flowchart illustrating an operation of the communication system according to the first exemplary embodiment of the present invention. As illustrated in FIG. 4, first, the control apparatus 20 collects traffic information from each of the nodes 10, as illustrated in FIG. 5 (step S001 and S101).

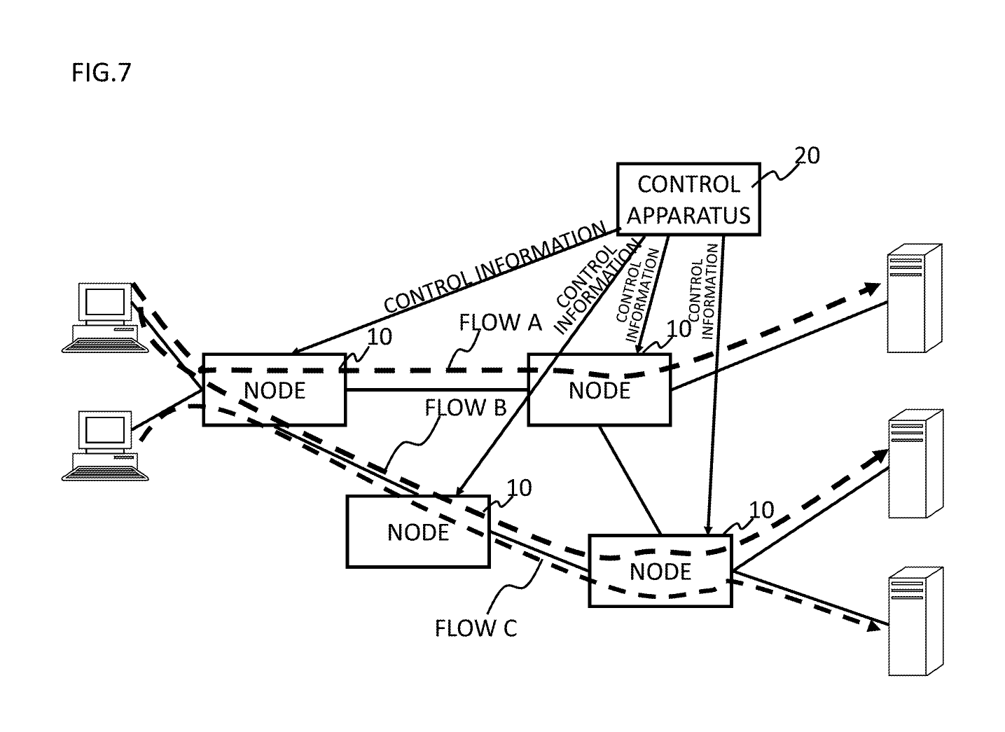

Next, the control apparatus 20 analyzes the collected traffic information (step S002) and determines whether control information (flow entries) needs to be preset in the nodes (step S003). If the control apparatus 20 determines that control information needs to be preset, the control apparatus 20 generates and sets preset control information (flow entries) in the node on the paths (step S004). FIG. 6 illustrates flows A to C that have been determined as preset target flows whose traffic rapidly increases in a certain time period. FIG. 7 illustrates an operation of setting control information (flow entries) for processing flows A to C.

When a node 10 is requested to set control information (a flow entry), the node 10 determines whether the control information storage unit 103 thereof has available storage space (step S102). If so, the node 10 stores the control information (the flow entry) received by the control information storage unit 103 (step S103).

However, if there is no available storage space in the control information storage unit 103, the node 10 causes the entry selection and deletion unit 104 to select control information (a flow entry) to be replaced and switches the control information (flow entries) (step S104).

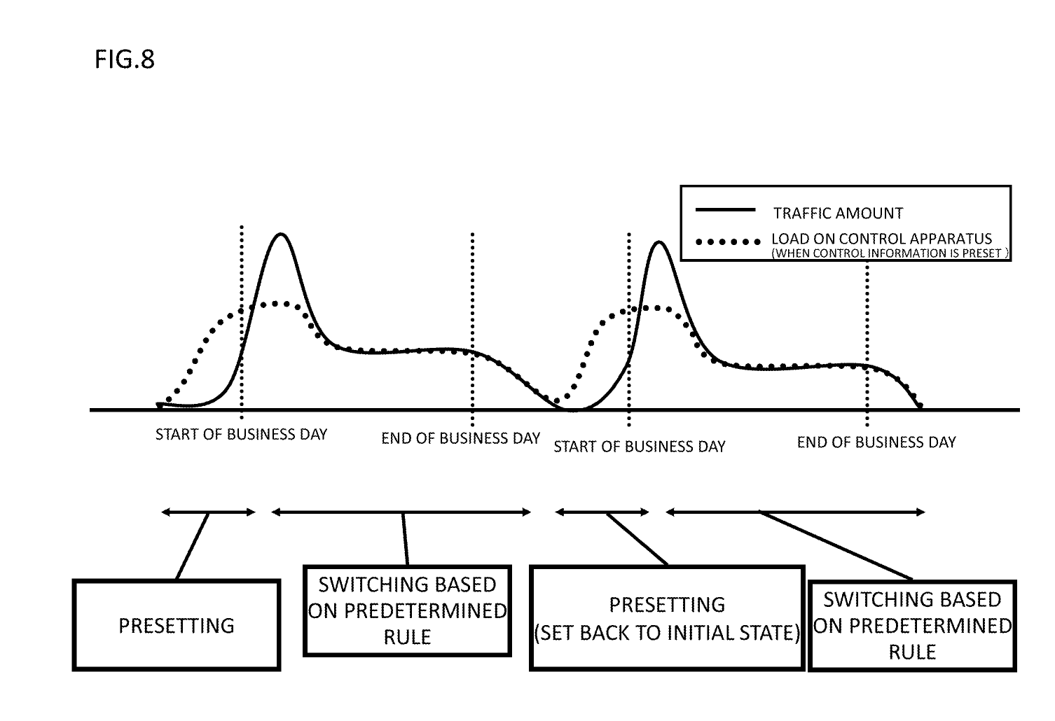

FIG. 8 is a graph illustrating an exemplary operation of the control apparatus 20 performed after preset target flows are determined as described above. In FIG. 8, the control apparatus 20 starts an operation of presetting control information (flow entries) before the start of a business day, that is, before the traffic amount reaches its peak. Therefore, the load observed before the start of a business day is heavier than the load observed when control information is not preset. Instead, the load observed when the traffic reaches its peak after the start of the business day is successfully reduced.

After the control information (flow entries) is preset, the control apparatus 20 sets control information (flow entries) in response to occurrence of new flows, for example. However, since the control information storage unit 103 does not have any available space, control information (flow entry) switching control is performed by using a predetermined rule such as the LRU or LFU algorithm.

From the next day on, since the control apparatus 20 presets control information (flow entries) before the start of a business day and performs the switching operation, reduction of the load on the control apparatus 20 is continuously achieved. While not particularly illustrated in FIG. 8, preset target flows may be changed between the first day and the second day. For example, the traffic information collection unit 201 and the traffic analysis unit 202 may be operated every day to determine flows for which control information (flow entries) is preset the next day and set the control information.

While an exemplary embodiment of the present invention has thus been described, the present invention is not limited thereto. Further variations, substitutions, or adjustments can be made without departing from the basic technical concept of the present invention. For example, the configurations of the networks and elements illustrated in the drawings are used only as examples to facilitate understanding of the present invention. Namely, the present invention is not limited to the configurations illustrated in the drawings.

In addition, in the above exemplary embodiment, after control information (flow entries) is preset, a switching operation is performed. However, the control apparatus 20 may give an instruction for deleting preset control information (a flow entry) a certain time period after the control information (the flow entry) is preset. In this way, the amount of control information (the number of flow entries) stored in each node 10 at times other than a traffic peak time can be reduced.

In addition, in the above exemplary embodiment, control information (flow entries) is preset until the control information storage unit 103 runs out of available storage space. However, certain storage space may be allocated for on-demand control information (flow entries) that needs to be set.

In addition, in the above exemplary embodiment, control information (flow entries) is preset on the basis of change of the traffic amount in one day. However, whether to set preset control information (flow entries) may be determined in a long-term view such as in a week, month, or the like. In this way, it is possible to reduce the load at a traffic peak in a long-term period, such as on a certain day in a week or at the beginning or the end of the month. For example, if the number of communications to a certain server is particularly high on a certain day of the month, by presetting control information (flow entries) for processing the communications to this server, the load on the control apparatus 20 can be reduced.

Likewise, in a shorter period such as one hour to a few hours, whether to set preset control information (flow entries) may be determined. In this way, reduction of the load at periodic traffic peaks every few minutes or every dozen minutes can be achieved. For example, if the number of communications to a certain server is particularly high every dozen minutes, by presetting control information (flow entries) for processing the communications to this server, the load on the control apparatus 20 can be reduced.

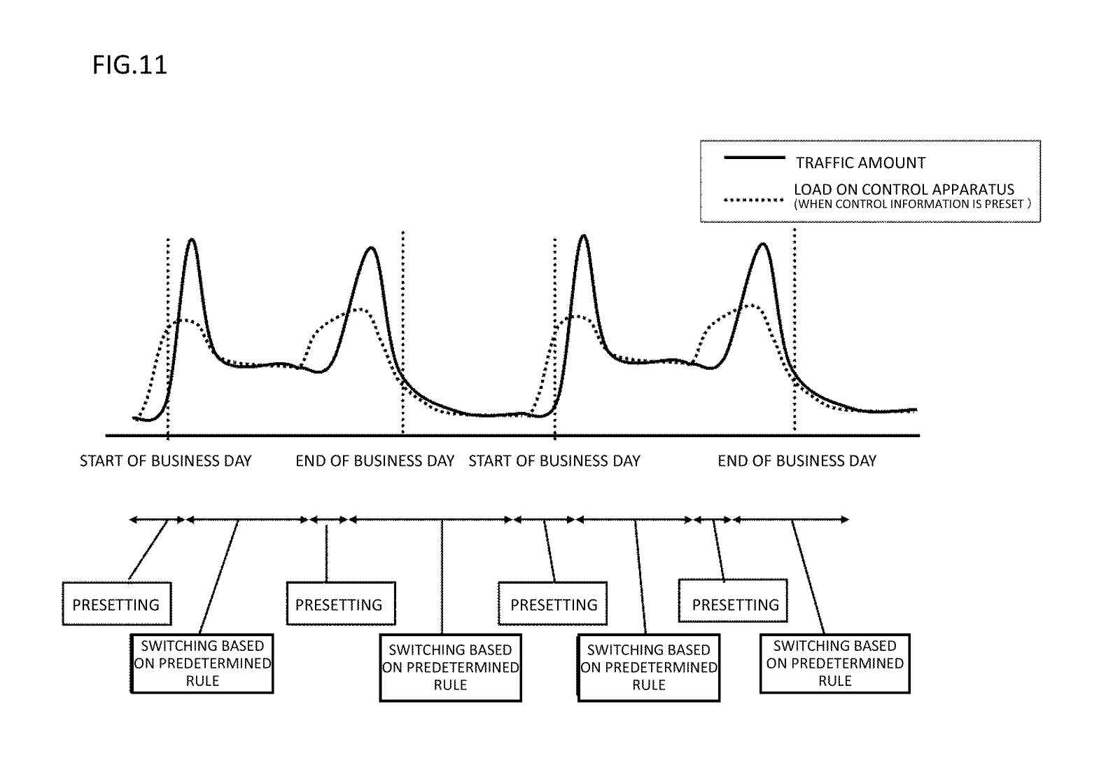

In addition, a single analysis period includes one traffic amount peak in the above example. However, if a single analysis period includes a plurality of peaks as illustrated in FIG. 11, each of the peaks may be analyzed, and control information (flow entries) may be preset for the next period on the basis of the analysis result of each peak.

In addition, in the above exemplary embodiment, the entry selection and deletion unit 104 is included in each node 10. However, each node 10 may be configured without the entry selection and deletion unit 104. In such case, the control apparatus 20 may switch preset control information (flow entries). Alternatively, as a variation, the control apparatus 20 may select some of the preset control information (flow entries), set time-out values in the selected preset control information (flow entries), and cause each node 10 to automatically delete such preset control information (flow entries).

In addition, in the exemplary embodiment, the control apparatus 20 includes the traffic information collection unit 201 and the traffic analysis unit 202. However, a separate apparatus having functions corresponding to those of the traffic information collection unit 201 and the traffic analysis unit 202 may be provided. In this way, the control apparatus 20 can be configured by a plurality of apparatuses. In such case, the control apparatus 20 receives a traffic analysis result from the separate apparatus and presets control information (flow entries).

Finally, suitable modes of the present invention will be summarized.

### (Mode 1)

See the control apparatus according to the above first aspect.

### (Mode 2)

The control apparatus; wherein the traffic analysis unit determines per time interval a plurality of flows whose traffic is expected to increase; and wherein the presetting unit sets a plurality of control information items for processing the determined plurality of flows in the node.

### (Mode 3)

The control apparatus; wherein the traffic analysis unit selects a plurality of flows whose maximum traffic value during a certain time period in one or mode nodes is relatively larger.

### (Mode 4)

The control apparatus; wherein the traffic analysis unit selects a plurality of flows whose total traffic amount during a certain time period in one or more nodes is relatively larger.

### (Mode 5)

The control apparatus; wherein the presetting unit sets the control information so that the control information is not deleted by time out in the node.

### (Mode 6)

The control apparatus; wherein, when setting new control information, the presetting unit replaces control information selected using a predetermined rule by the new control information.

### (Mode 7)

See the node according to the above second aspect.

### (Mode 8)

See the communication system according to the above third aspect.

### (Mode 9)

See the communication method according to the above fourth aspect.

### (Mode 10)

See the program according to the above fifth aspect.
The above modes 7 to 10 can be expanded in the same way as mode 1 is expanded to modes 2 to 6.

The disclosure of each of the above Patent Literature and Non-Patent Literatures is incorporated herein by reference thereto. Modifications and adjustments of the exemplary embodiments and the examples are possible within the scope of the overall disclosure (including the claims) of the present invention and based on the basic technical concept of the present invention. In addition, various combinations and selections of various disclosed elements (including the elements in each of the claims, exemplary embodiments, examples, drawings, etc.) are possible within the scope of the claims of the present invention. Namely, the present invention of course includes various variations and modifications that could be made by those skilled in the art according to the overall disclosure including the claims and the technical concept. In particular, the present description discloses numerical value ranges. However, even if the description does not particularly disclose arbitrary numerical values or small ranges included in the ranges, these values and ranges should be deemed to have been specifically disclosed.

### REFERENCE SIGNS LIST

10, 10A node
20, 20A control apparatus
101 traffic information provision unit
102 packet processing unit
103 control information storage unit
104 entry selection and deletion unit
201 traffic information collection unit
202 traffic analysis unit
203 presetting unit
204 on-demand setting unit

1. A control apparatus, comprising:
a traffic information collection unit that collects per-flow traffic information from a control target node for performing packet processing per flow;
a traffic analysis unit that performs totalization per flow based the traffic information to determine a flow whose traffic is expected to increase and a corresponding time period; and
a presetting unit that presets control information for processing the determined flow in a node on a path that corresponds to the flow whose traffic is expected to increase during the determined time period.

2. The control apparatus according to claim 1,
wherein the traffic analysis unit determines per time interval a plurality of flows whose traffic is expected to increase; and
wherein the presetting unit sets a plurality of control information items for processing the determined plurality of flows in the node.

3. The control apparatus according to claim 2,
wherein the traffic analysis unit selects a plurality of flows whose maximum traffic value during a certain time period in one or mode nodes is relatively larger.

4. The control apparatus according to claim 2,
wherein the traffic analysis unit selects a plurality of flows whose total traffic amount during a certain time period in one or more nodes is relatively larger.

5. The control apparatus according to claim 1,
wherein the presetting unit sets the control information so that the control information is not deleted by time out in the node.

6. The control apparatus according to claim 1,
wherein, when setting new control information, the presetting unit replaces control information selected using a predetermined rule by the new control information.

7. A node, comprising:
a traffic information provision unit that transmits per-flow traffic information in response to a request from a control apparatus;
a control information storage unit that stores control information received from the control apparatus; and
an entry selection and deletion unit that selects, when a count of preset control information items generated based on the traffic information transmitted to the control apparatus reaches a predetermined count, control information using a predetermined rule from the preset control information items and deletes the selected control information.

8. A node, comprising:
a traffic information provision unit that transmits the traffic information to the control apparatus according to claim 1; and
a packet processing unit that processes a packet in accordance with control information received from the control apparatus.

9. The node according to claim 8, comprising:
a control information storage unit that stores control information received from the control apparatus; and
an entry selection and deletion unit that selects, when a count of preset control information items generated based on the traffic information transmitted to the control apparatus reaches a predetermined count, control information using a predetermined rule from the preset control information items and deletes the selected control information.

10. The node according to claim 7,
wherein the entry selection and deletion unit selects control information from the preset control information items based on a use status of the control information and deletes the selected control information.

11. A communication system, comprising:
the control apparatus according to claim 1; and
a node that transmits the traffic information to the control apparatus and operates in accordance with control information received from the control apparatus.

12. A communication method, comprising:
by a control apparatus that controls a node for performing packet processing per flow, collecting per-flow traffic information from the node;
performing totalization per flow based on the traffic information to determine a flow whose traffic is expected to increase and a corresponding time period; and
presetting control information for processing the determined flow in a node on a path that corresponds to the flow whose traffic is expected to increase during the determined time period.

13. The communication method according to claim 12;
wherein the determination comprises determining per time interval a plurality of flows whose traffic is expected to increase; and
wherein the presetting comprises setting a plurality of control information items for processing the determined plurality of flows in the node.

14. The communication method according to claim 13;
wherein the determination comprises selecting a plurality of flows whose maximum traffic value during a certain time period in one or more nodes is relatively larger.

15. The communication method according to claim 13;
wherein the determination comprises selecting a plurality of flows whose total traffic amount during a certain time period in one or more nodes is relatively larger.

16. The communication method according to claim 13;
wherein the presetting comprises setting the control information so that the control information is not deleted by time out in the node.

17. The communication method according to claim 12;
wherein the presetting comprises replacing, when new control information is set, control information selected using a predetermined rule by the new control information.

18. A non-transitory computer-readable recording medium storing a program that causes a computer, arranged in a control apparatus that controls nodes that perform packet processing per flow, to execute:
collecting per-flow traffic information from the node;
performing totalization per flow based on the traffic information to determine a flow whose traffic is expected to increase and a corresponding time period; and
presetting control information for processing the determined flow in a node on a path that corresponds to the flow whose traffic is expected to increase during the determined time period.
